(19) United States
(12) Patent Application Publication
(10) Pub. No.: US 2006/0144773 A1
(43) Pub. Date: Jul. 6, 2006

(54) Device for collecting items floating at the surface of the sea

(76) Inventor: Thierry Thomazeau, Saint Hilaire De Riez (FR)

Correspondence Address: YOUNG & THOMPSON, 745 SOUTH 23RD STREET, 2ND FLOOR, ARLINGTON, VA, 22202, US

(21) Appl. No.: 10/538,848

(22) PCT Filed: Dec. 10, 2003
(86) PCT No.: PCT/FR03/03652

§ 371 Date: Jan. 4, 2006

(30) Foreign Application Priority Data
Dec. 13, 2002 (FR) 0215870
Jul. 21, 2003 (FR) 0308853

(51) Int. Cl. B01D 29/00

(52) U.S. Cl. 210/241

(57) ABSTRACT

The invention concerns a device for collecting various items, such as waste, containers or other products, floating at the surface of an aqueous medium, such as sea, river. Said device designed to be towed by one or two boats, essentially consists of at least one filtering bag (1), such as a trawl-net, for confining items to be collected and of a structure (2) whereon the confinement bag (1) is fixed. The confinement bag (1) is detachably fixed on its entire length to said structure (2). The structure (2) is an inflatable structure fixed to the outside of the bag (1) and which, when inflated, maintains at least part of the bag (1) , in particular on the side of the opening of said bag (1), above and/or at the surface of the water. The invention is useful in particular for collecting hydrocarbons.

This invention relates to a device for collecting floating articles, such as hydrocarbons, containers, large pieces of waste material and others, floating on the surface of an aqueous environment, such as the sea, a river . . .

To recover floating products at sea, there are currently various techniques that are chosen depending on the type of products to be collected.

Thus, for layers of hydrocarbons due to illegal dumping of oil by ships or foundering of oil tankers, pump vessels are used to collect the floating hydrocarbons.

This type of pumping device has the disadvantage of not being fast and not allowing large amounts of hydrocarbons to be pumped, especially when they are too viscous.

Then, pumping devices were proposed that allow the hydrocarbons to be guided beforehand toward a pumping location encircled in such a manner as to facilitate said pumping.

Thus, FR-A-2 383 272 proposes a petroleum collection device comprising a bag of impermeable material that generally extends horizontally and that is pulled by at least one vessel. This device likewise comprises two purlins (arms) fixed to the opening of the bag and extending toward the outside and the front of the bag in the direction of towing. The purlins each comprise a buoyant element preferably with the shape of an inflatable tube. The purlins are connected next to the opening to a buoyant element that extends along the opening of the bag. The bag comprises a second buoyant element extending in a V shape from the ends in front of the purlins and the rear portion of the bag. This inflatable V-shaped structure makes it possible to impart to the device a mechanical resistance and stability that have been improved without cost to flexibility. Said V-shaped structure is composed of an inflatable tube contained partially in the bag and fixed to the upper portion of the bag.

This device, however, has a major disadvantage in that since the inflatable structure is connected to the pocket, it is not possible to disconnect the pocket to re-use the structure with another pocket. Accordingly, to be able to re-use the device, it is a good idea to pump its contents. This has the result that such a device is very awkward, since it requires either pumping of the contents of the pocket for purposes of its re-use or complete replacement of the device if the latter is not pumped. In both cases, even if the hydrocarbons are guided toward a receiving pocket, the material comprising this pocket being impermeable, the captured water likewise with the hydrocarbons limits the effectiveness of collection of hydrocarbons.

U.S. Pat. No. 5,531,890 proposed a device comprising confinement purlins that guide the petroleum toward a skimmer, then toward a water/petroleum separation tank wherein a polymer material absorbs the petroleum. This device is equivalent to a petroleum pumping device, i.e., it is difficult-to implement in bad weather at sea.

In U.S. Pat. No. 3,771,662, the described device comprises a barrier line pulled by two vessels so as to collect and confine the petroleum. Thus, scraping the petroleum on the surface of the water before being able to pump it is proposed.

WO/02 12636 proposes a device for trapping the layers of petroleum, the entry being formed as a funnel to guide the petroleum toward a tank where it is stored, to then be pumped.

None of the above-described devices suggests collection without pumping of the hydrocarbons using a simple and economical device.

Moreover, for other products, it is a good idea to find other collection devices, of which it has been established that they are not very efficient during a very large-scale oil spill.

Moreover, multiplication of these numerous and varied devices depending on the object increases the costs (one device depending on each type of product to be collected).

A collection device has likewise been proposed that comprises an elongated pocket of the “sock” type whose mouth is mounted on a rigid ring, this ring being carried by buoyant rigid arms that are mounted on each side of the ring and that keep the latter in a vertical plane relative to the surface of the sea. This device extends between two vessels, the opening of the pocket being located on the surface and collecting the hydrocarbons located on the surface. In this device, however, except for the opening of the pocket that is kept rigid, the remainder of said pocket is located underwater and it could be observed that the device is not as efficient as could be expected. Moreover, this rigid stricture is bulky and cannot be easily transported for prompt use.

To eliminate these disadvantages, the object of this invention is to propose a device for collecting floating products on the open sea but that can be used equally well on the roads, in estuaries, ports, rivers, i.e., wherever this is possible and necessary, and that is easy to use and transport for prompt intervention.

To do this, the object of the invention is a device for collecting various articles, such as scrap, containers or other products floating on the surface of an aqueous environment, such as the sea or a river, this device, that is designed to be towed by one or two vessels, being composed essentially of at least one filtering pocket, such as a drag-net, for confinement of articles to be collected, and of a structure on which the confinement pocket is fixed, characterized in that the confinement pocket is fixed in a separable manner over its entire length to said structure, and in that the structure is an inflatable structure that is fixed to the outside of the pocket and that, when inflated, keeps at least part of the pocket, especially next to the opening of said pocket, above and/or at the level of the surface of the water.

Thus, the opening of the pocket is located advantageously at least partially above sea level and below said sea level such that the floating products enter the pocket by said opening that in some way swallows them. In addition, however, the remainder of the pocket is kept over the entire length of the pocket in a position that is essentially horizontal in which the opening and the bottom of the pocket are arranged on the same line with the plane of the opening of the pocket extending essentially perpendicular to the surface of the sea such that the products can penetrate to the bottom of said drag-net, guaranteeing that the collection device according to the invention has optimum efficiency.

According to one particularly advantageous embodiment, the inflatable structure is lengthened beyond the opening of the confinement pocket of the drag-net, in the form of two arms of differing aspect to form an entry guide for articles floating toward the opening of the pocket of the drag-net.

Preferably, the pocket of the drag-net comprises fixed ballast, for example on the pocket in such a way as to be located opposite an inflatable structure.

The pocket of the drag-net is preferably a canvas pocket that is permeable to water but impermeable to hydrocarbons.

Very advantageously, the device according to the invention is disposable. Thus, the confinement pocket that can be easily separated from the remainder of the device can be thrown out with its contents. The inflatable structure of the device can then be used with a new pocket.

In a variant, the separation of the pocket of the inflatable structure from the device according to the invention likewise makes it possible to bring its contents toward a station for reprocessing said contents, and thus to recover said pocket after emptying for re-use.

This invention thus makes it possible to re-use the entire pocket device/inflatable structure, and at the very least the inflatable structure, which is not always the case for the devices proposed previously.

This separation of the inflatable structure from the pocket is advantageously possible because the inflatable structure is located outside of the pocket, thus making it possible to avoid any direct contact between the hydrocarbons contained in the pocket and the inflatable structure.

Thus, before use, the pocket and inflatable structure combination when not inflated is ready for use and easily transported, the combination able to be folded or rolled around a drag-net winding device. In use, the inflatable structure is inflated, and the confinement pocket is then located partially out of the water to collect waste. Once the products to be collected have been introduced into the confinement pocket and the bottom of the pocket is filled, the latter can be closed using a closing cable and the pollutant that is confined in this way can then be taken to a specific recovery site.

Since it is possible to separate the inflatable structure from the pocket to dispose of it or to treat the contents of the pocket,

The device according to the invention is thus not overly cumbersome since it is folded or rolled onto drag-net winding devices, and consequently can be easily transported on ships to reach the intervention site. Moreover, it can be left aboard ships such as trawlers, naval vessels and others, which allows its use when necessary.

The invention will now be described in greater detail with reference to the drawings, in which:

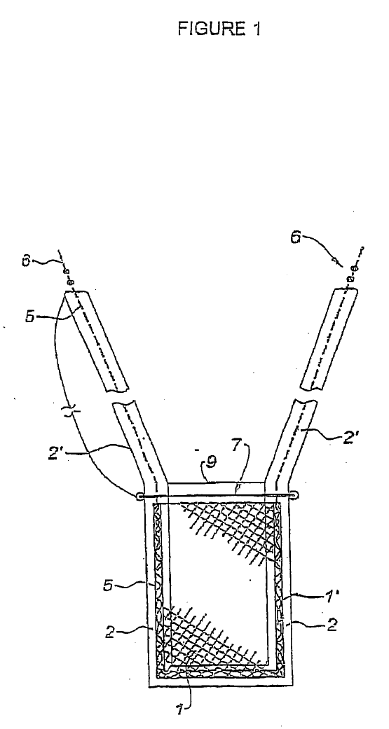

FIG. 1 schematically shows a top view of the collecting device according to the invention;

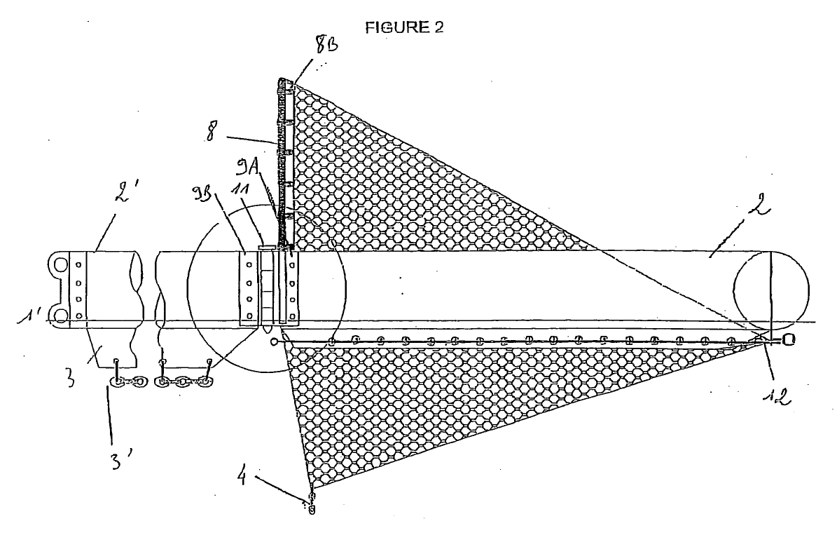

FIG. 2 schematically shows a side view of the device according to FIG. 1;

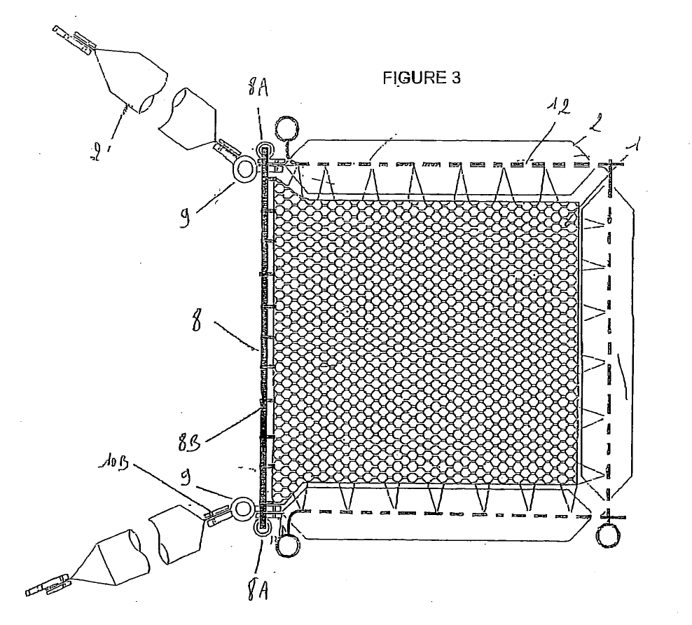

FIG. 3 schematically shows a partial top view of the device of FIG. 2;

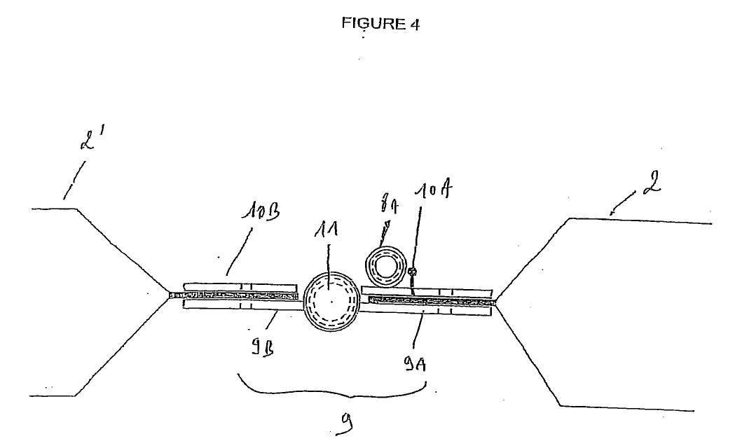

FIG. 4 shows a detailed schematic view of the linkage of the arm to the inflatable structure of FIG. 2, and

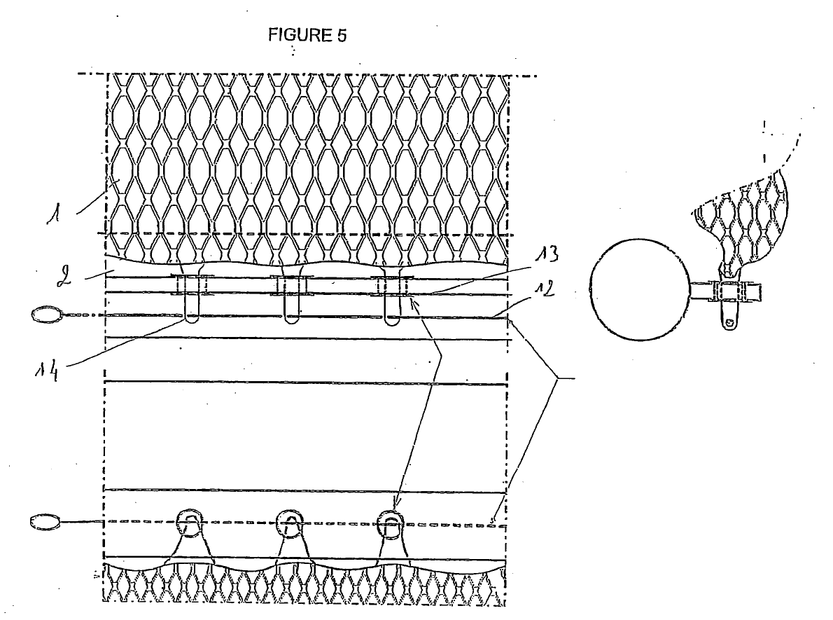

FIG. 5 shows a front view of the means of connecting the pocket to the inflatable structure.

As mentioned above, the collection device, the object of the invention, allows collection of various articles such as waste, containers or others, floating on the surface of an aqueous environment, such as the sea, a river or the like.

This collection device is composed essentially of at least one filtering pocket 1, generally of the net type, which is used for confinement of the articles to be collected, and of a structure 2 on which the confinement pocket 1 is fixed. This collection device is towed by one or two ships. In a manner characteristic of the invention, the confinement pocket 1 is fixed over its entire length to the structure 2 to allow this pocket to be kept in the stretched-out position relative to the surface of the water. This pocket can assume the classic shape of a drag-net and for this reason comprises an opening and a bottom. The structure 2 for itself is an inflatable structure that when inflated keeps at least part of the pocket 1, in particular next to the opening of said pocket, above and/or at the level of the water's surface. This combination thus allows filling of the entire pocket since keeping it in the stretched-out position makes the entire volume of the pocket accessible and prevents the articles that are to be collected from passing above the top edge of the opening of the pocket, in particular when the device is being dragged on the surface of the sea and when this sea is stormy.

Preferably the inflatable structure 2 over more or less the entire length keeps at least part of the confinement pocket 1 above and/or essentially at the level of the surface 1′ of the sea. It should be noted that the confinement pocket 1 has the shape of a double envelope formed preferably in the shape of two pockets housed within one another, the outside pocket that forms the reinforcement being made of a material with less elasticity than that of the material comprising the inside confinement pocket. This confinement pocket 1 is a canvas pocket that is permeable to the water, but impermeable to hydrocarbons.

The inflatable structure 2 for itself is lengthened beyond the opening of the confinement pocket 1 in the form of two arms 2′ of differing aspect to form an entry guide for articles floating toward the opening of the pocket 1 of the drag-net. Each arm 2′ is connected to the remainder of the inflatable structure 2 via a removable link 9 such as an articulated link of the hinge type. This link 9 of the hinge type is composed of two elements 9B, 9A, respectively, 9B being integral with the arm 2, the other, 9A, integral with the remainder of the inflatable structure 2. These elements 9A, 9B of the hinge 9 are joined to one another via a removable axis 11 that allows rapid separation between the arm 2′ and the remainder of the inflatable structure 2. Thus, these elements 9A, 9B are made in the form of hinge-pins that can be fitted to one another via an axis 11 inserted inside said hinge-pins. Each element is, moreover, provided with a plate that can be connected to a backplate, shown at 10A, 10B of the figures, in such a way as to enclose between the plates and the element 9A or 9B a wing of the arm 2′ or the remainder of the inflatable structure 2. This embodiment is shown more particularly in FIGS. 3 and 4. The presence of this hinge-type link makes it possible, on the one hand, to optionally vary the angle formed between the arms 2′ in such a way as to more or less open the funnel formed by said arms, on the other hand to facilitate the separation of the arm 2′ from the remainder of the inflatable structure 2, the simple removal of the axis 11 allowing such a separation.

In the examples shown, each arm 2′ preferably has the shape of at least one inflatable fender and on its base along its generatrices is provided with a skirt 3 with ballast by means of the ballasting chain shown at 3′ in the figures. The inflatable structure 2 for itself is composed of a plurality of inflatable beams forming essentially a U in the horizontal plane, i.e., a recumbent U. This inflatable structure could be similarly composed of two inflatable beams extending parallel to one another and of a third beam extending perpendicular to said parallel beams. It could likewise be a structure composed of a single, inflatable, recumbent U-shaped piece. The confinement pocket 1 is designed to be housed within the U. This pocket 1 preferably has a ballast 4 fixed to the pocket 1 with respect to the inflatable structure. This ballast can be arranged continuously or intermittently in the shape of a U according to the inflatable structure 2.

To allow the confinement pocket 1 to be kept at a level corresponding to that which is desired, in the vicinity of the entry opening of the confinement pocket 1, there is an inflatable or rigid frame in the shape of an arch 8, one edge of the opening of the pocket 1 being fixed on this arched frame 8. The frame in the shape of an arch 8 is kept in the raised position of the arch 8 by two arch supports 8A, each composed of at least one element, preferably tubular, located in the vicinity of the connecting zone between the arm 2′ and the inflatable structure 2 and joined to the arm 2 and/or the inflatable structure 2, each arch support 8A being used to house, in a movable maimer, an upright of the arch 8, the peak of the arch 8 being used to fix one edge, the so-called upper edge of the confinement pocket 1, preferably via a strap 8B.

In the example shown, the inflatable structure in the vicinity of its zone of linkage to the arms 2′ is equipped with arch supports 8A that are each designed to house, in a movable manner, an upright of the arch 8. The peak of the arch 8 is used to fix one edge, the so-called upper edge of the confinement pocket 1, preferably via a strap 8B.

Obviously, other embodiments can be envisaged in which in the vicinity of the entry opening of the confinement pocket 1, there is an inflatable or rigid frame in the shape of an arch 8, one edge of the opening of the pocket 1 being fixed on this arched frame 8. Due to this configuration, at least one part of the confinement pocket 1 is located above the level of the surface of the water when the inflatable structure 2 is inflated. This inflation of the inflatable structure 2 occurs when the collection device is-put into the water to perform its collection function.

The confinement pocket 1 is connected to the inflatable structure 2 by a holding cable 12 threaded within the gaskets in the form of a loop 14, which gaskets are integral with the confinement pocket 1. These gaskets 14 are inserted beforehand through eyelets 13 integral with the inflatable structure 2 in such a manner as to make these eyelets project. The cable 12 is then threaded within this projecting portion of the gaskets 14 to allow joining of the inflatable structure 2 and the confinement pocket 1. Disconnection of the inflatable structure/pocket is obtained by simply removing the holding cable 12. These different connections of the confinement pocket 1 to the arch 8, on the one hand, and to the inflatable structure 2, on the other hand, allow, once the collection device is at sea and the collection operation completed, very quick separation of the different components of the collection device from one another. Thus, first the arms 2′ are separated from the remainder of the inflatable structure by removing the axis 11 of the hinge, then the arch 8 is removed by simply cutting the gaskets or the loop 8B connecting the confinement pocket 1 to the arch 8. Finally, it is then sufficient to remove the holding cable 12 to definitively separate the inflatable structure 2 from the confinement pocket 1. These operations can thus be carried out in a few dozen minutes. Once the pocket is recovered and disconnected from the inflatable structure 2, the latter can be placed in a container, and the fuel oil contained in the pocket can be re-used, for example, in a cement plant as fuel. In certain applications, it is thus of prime importance that the inflatable structure 2, the arms 2′ and the confinement pocket 1 be easily separable from one another. In another embodiment, not shown, the bottom of the confinement pocket 1 is equipped with a slide fastener to allow the pocket 1 to be emptied and re-used. In this case, the pocket 1 is re-usable.

As mentioned above, the collection device according to the invention is generally towed by two vessels using a strap, such as a cable or a towing strap 5, which preferably follows the line of the inflatable structure 2 in such a way as to better distribute the pull on the device. This cable or towing strap 5 is connected to a cable 6 linked to the ship via a swivel block.

The opening of the pocket 1 for its part is provided with a closing cable 7 that can be remotely activated. Thus, once the pocket 1 is filled with waste to be collected, activation of said cable 7 makes it possible to close the pocket and to hold the waste inside. The collection device can then be hoisted aboard one of the vessels or can be towed to the waste recovery site. The pocket I can then be separated from the structure 2 to allow it to be emptied.

According to the type of waste to be collected, the inflatable structure of the device according to the invention can likewise comprise a transverse beam positioned at the opening of the confinement pocket 1.

Preferably a cable, not shown, is likewise placed at the entry of the confinement pocket 1 in order to define a maximum width of the opening of said confinement pocket 1.

1. Device for collecting various articles, such as scrap, containers or other objects floating on the surface of an aqueous environment, such as the sea or a river, this device, which is designed to be towed by one or two vessels, being composed essentially of at least one filtering pocket (1), such as a drag-net, for confinement of articles to be collected, and of a structure (2) on which the confinement pocket (1) is fixed, characterized in that the confinement pocket (1) is fixed in a separable manner over its entire length to said structure (2), and in that the structure (2) is an inflatable structure that is fixed to the outside of the pocket (1) and that when inflated keeps at least part of the pocket (1), especially next to the opening of said pocket (1), above and/or at the level of the surface of the water.

2. Device according to claim 1, wherein the inflatable structure (2) over more or less the entire length keeps at least part of the confinement pocket (1) above and/or essentially at the level of the surface (1′) of the sea.

3. Device according to claim 1, wherein the inflatable structure (2) is lengthened beyond the opening of the confinement pocket (1) in the form of two arms (2′) of differing aspect to form an entry guide for articles floating toward the opening of the pocket (1) of the drag-net.

4. Device according to claim 3, wherein each arm (2′) is connected to the remainder of the inflatable structure (2) via a removable link (9) such as an articulated link of the hinge type to allow rapid separation of the arms (2′) from the remainder of the inflatable structure (2).

5. Device according to claim 4, wherein the removable link (9) of hinge type is composed of two elements (9B, 9A) respectively, 9B being integral with the arm (2), the other, (9A), integral with the remainder of the inflatable structure (2), said elements (9A, 9B) of the hinge (9) being joined to one another via a removable axis (11) that allows rapid separation between the arm (2) and the remainder of the inflatable structure (2).

6. Device according to claim 3, wherein each arm (2′) preferably has the shape of at least one inflatable fender and on its base along its generatrices is provided with a skirt (3) with ballast.

7. Device according to claim 1, wherein the inflatable structure (2) is composed of a plurality of inflatable beams forming essentially a U in the horizontal plane.

8. Device according to claim 1, wherein in the vicinity of the entry opening of the confinement pocket (1), there is an inflatable or rigid frame in the shape of an arch (8), one edge of the opening of the pocket (1) being fixed on this arched frame (8).

9. Device according to claim 8, wherein the frame in the shape of an arch (8) is kept in the raised position of the arch (8) by two arch supports (8A), each composed of at least one element, preferably tubular, located in the vicinity of the connecting zone between the arm (2′) and the inflatable structure (2) and joined to the arm (2) and/or the inflatable structure (2), each arch support (8A) being used to house, in a movable manner, an upright of the arch (8), the peak of the arch (8) being used to fix one edge, the so-called upper edge of the confinement pocket (1), preferably via a strap (8B).

10. Device according to claim 1, wherein the confinement pocket (1) is connected to the inflatable structure (2) by a holding cable (12) that is threaded within the gaskets in the form of a loop (14), which gaskets are integral with the confinement pocket (1) and project through the eyelets (13) that are integral with the inflatable structure (2), disconnection of the inflatable structure/pocket being obtained by simply removing the holding cable (12).

11. Device according to claim 1, wherein the confinement pocket (1) has the shape of two pockets housed within one another, the outside pocket that forms the reinforcement being made of a material with less elasticity than that of the material comprising the inside confinement pocket.

12. Device according to claim 1, wherein the bottom of the confinement pocket (1) is equipped with a slide fastener to allow the pocket (1) to be emptied and re-used.

13. Device according to claim 3, wherein the inflatable structure (2), the arms (2′) and the confinement pocket (1) can be separated from one another.

14. Device according to claim 2, wherein the inflatable structure (2) is lengthened beyond the opening of the confinement pocket (1) in the form of two arms (2′) of differing aspect to form an entry guide for articles floating toward the opening of the pocket (1) of the drag-net.
